(19) United States
(12) Patent Application Publication
(10) Pub. No.: US 2003/0004761 A1
(43) Pub. Date: Jan. 2, 2003

(54) System for reserving merchandise

(76) Inventors: Karen L. Lampe, West Palm Beach, FL (US); Stephen J. Budd, West Palm Beach, FL (US)

Correspondence Address: IP Department, SCHNADER HARRISON SEGAL & LEWIS, 36th Floor, 1600 Market Street, Philadelphia, PA, 19103, US

(21) Appl. No.: 09/894,012

(22) Filed: Jun. 28, 2001

(51) Int. Cl. G06F 17/60

(52) U.S. Cl. 705/5

(57) ABSTRACT

The present invention is directed to a system for reserving items over a computer network, which includes receiving inventory information about at least one item stored in at least one geographic location; storing the inventory information in a data source; receiving a request from a user to reserve the item; generating a reservation request based upon request from the user; sending the reservation request to the geographic location to activate an electronic tag assigned to the item to indicate that the item has been reserved; and

receiving a response from the geographic location that the electronic tag has been activated. This may be accomplished in the present invention through the use of an information exchange system that includes a Web server, a data source interface, a data source, and an email server.

### CROSS-REFERENCE TO RELATED APPLICATION

Not applicable.

### STATEMENT REGARDING FEDERALLY SPONSORED RESEARCH

Not applicable.

### REFERENCE TO MICROFICHE APPENDIX

Not applicable.

### BACKGROUND OF THE INVENTION

1. Field of the Invention

The present invention relates to a system for reserving merchandise, particularly to a system for reserving merchandise from across multiple vendors in specified geographic area, and more particularly to a system for reserving merchandise over the Internet from across multiple vendors in specified geographic areas.

2. Description of the Prior Art

The growing proliferation of businesses on large corporate, government, or public computers and computer networks, such as the Internet, as well as broadcast, cable, and satellite television has lead to a tremendous increase in the amount of purchasing being done on these systems. Each day, more businesses are offering their retail products online, as well as in brick and mortar locations.

This, in turn, has created a need for a more workable and more efficient system for accessing this information and for reserving items by placing them on hold or on “layaway.” This problem is explained below in more detail in regard to the Internet, but is not limited thereto.

The Internet is a vast “network of networks” connecting a large number of computer networks and sub-networks to each other through several regional (geographically diverse) backbone systems. The Internet is a “decentralized” network, which means that each computer on the network can communicate with each other computer on the network, regardless of its location, and can do so without communicating with a central computer. One portion of the Internet, the World Wide Web (“Web”), is growing at a rapid pace, as more and more individuals and organizations go online.

The Web is the most popular segment of the Internet today because it allows users to interact with each other and access content through a graphical user interface, or “GUI.” The same is true for today's computer operating systems. GUIs provide the distinct advantage that they allow users to navigate and retrieve information visually, which allows them to be more intuitive in nature.

The systems of the prior art have had the significant disadvantage that, while purchasers can research products online and can make purchases, they cannot physically examine the product that they are purchasing, and cannot reserve the product for examination at their local vendor. For example, many prior art systems exist for comparing and order products over the Internet and computer networks, such as U.S. Pat. Nos. 6,076,071; 6,076,070; 6,009,413; 5,991,739; 5,960,411; 5,946,665; 5,913,210; 5,878,416; 5,873,069; 5,870,716; 5,797,132; and others. The subject matter of these patents is hereby incorporated by reference herein.

It is also known in the prior art to affix stocked items for purchase with electronic tags for inventory and re-stocking purposes. Examples of such systems are disclosed in U.S. Pat. Nos. 6,058,374; 6,057,756; 6,025,780; 5,963,133; 5,774,876; and others. The subject matter of these patents is hereby incorporated by reference herein.

However, none of these prior art systems provides a way for the potential purchaser to view and compare the inventory of several vendors at once, and to reserve the item for inspection locally prior to purchase.

Accordingly, a system is needed that will allow purchasers to access the Internet or similar types of networks via their computer, television, PDA, and the like, in order to review the inventory of multiple vendors, and to place an item on hold at a vendor in a particular geographic location. Moreover, a system is also needed that is capable of alerting retail personnel and the purchasing public that the particular item on the store shelf is, in fact, on hold, and not available for purchase.

### SUMMARY OF THE INVENTION

The present invention is directed to a system for reserving items over a computer network, which includes receiving inventory information about at least one item stored in at least one geographic location; storing the inventory information in a data source; receiving a request from a user to reserve the item; generating a reservation request based upon request from the user; sending the reservation request to the geographic location to activate an electronic tag assigned to the item to indicate that the item has been reserved; and

receiving a response from the geographic location that the electronic tag has been activated. This may be accomplished in the present invention through the use of an information exchange system that includes a Web server, a data source interface, a data source, and an email server.

### BRIEF DESCRIPTION OF THE DRAWINGS

FIG. 1 is a diagram illustrating a preferred embodiment of the invention used over the Internet.

FIG. 2 is a schematic illustrating a preferred embodiment of the electronic tag of the present invention.

FIG. 3 is an overhead drawing of store utilizing a preferred embodiment of the present invention.

### DETAILED DESCRIPTION OF THE PREFERRED EMBODIMENT

The present invention will be understood more fully from the detailed description given below and from the accompanying drawings of preferred embodiments of the invention, which, however, should not be taken to limit the invention to a specific embodiment but are for explanation and understanding only.

The present invention is directed to a system that allows users from diverse geographic regions to automatically reserve desired items of merchandise to be purchased at a physical store near them. One preferred means of transmitting information over geographically diverse locations in use today is the Internet. While the present invention is described in more detail in regard to its use over the Internet, it is not limited thereto, and can be achieved with a variety of internetworked system, well known to those of ordinary skill in the art, such as virtual private networks and the like.

The Internet is a vast “network of networks” connecting a large number of computer networks and sub-networks to each other through several regional backbone systems around the world. One portion of the Internet, the World Wide Web (“Web”), is growing at a rapid pace, as more and more businesses go online.

The Web is the most popular segment of the Internet today because it allows users to interact with each other and access content through a graphical user interface, or “GUI.” The most commonly used GUI's are Web browsers, which are software applications that allow users to access and view electronic documents in a browser window.

Web documents are created using Hypertext Markup Language (“HTML”), which allows authors to add special format tags to plain text documents to control the appearance of the text in the Web browser. HTML tags also allow for the insertion of additional components into the Web document, such as image files, audio files, and applets. Applets are small pieces of programming code that are run on the user's computer when downloaded. Applets allow for such effects as scrolling text and animation, and for use in the secure transfer of information across the Internet.

To enhance security, Secure Socket Layer (“SSL”) technology may be used, which is widely known by those skilled in the art and is integrated into most commercially acceptable web browsers.

The following is a description of the item selection and hold system of the present invention. In a preferred embodiment of the invention (although not limited thereto), individual users (i.e. customers) physically located at a geographic location may submit their reservation request over the Internet, such as through the use of a series of HTML forms, to an information exchange system, which stores this information in a data source. This information exchange system identifies the stores carrying the desired item in the preferred geographic location designated by the customer, such as those nearest to the customer's home, and communicates with the inventory control system at that store or stores. The inventory control system, in turn, communicates with an electronic tag resident on the item or item packaging. When the electronic tag receives a communication that the item is to be placed on hold, it records this information and may begin emitting a signal (e.g. visual or audio) that alerts customers in the store that the item has been placed on hold and is not available. The electronic tag then sends a response back to the inventory control system, which may record the information, and which sends a response back to the information exchange system. The information exchange system, in turn, sends a response back to the customer indicating that the item has been placed on hold, where it can be purchased, and any other information necessary to complete the sale. Of course, customers may purchase items in this manner as well, and visit the local store to actually retrieve the item.

The operation of the system of the present invention will now be described in more detail. In this example, a User desires to place an item on hold that is carried by Store 1 and/or Store 2. Store 1 and Store 2 are located in geographic proximity to the User (e.g. in the same development, zip code, city, county, etc.). This proximity may be designated by the User, or be a default setting.

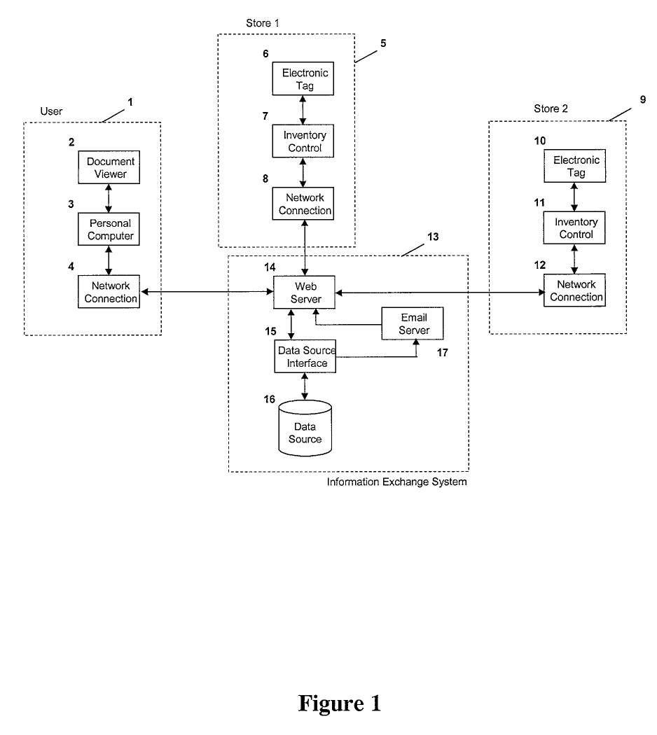

FIG. 1 is a schematic demonstrating the typical components used in a preferred embodiment of the invention when used over the Internet. An electronic document, such as a Web page created using HTML, is loaded into Document Viewer 1 by the User. The document viewer may be any software application capable of viewing electronic documents and loading additional electronic documents from within the original document, such as through the use of a hypertext link (although not limited thereto).

For example, the document viewer could include a Web browser, such as Navigator from Netscape Communications or Microsoft's Internet Explorer. The electronic document may be loaded automatically when the document viewer is first started, or may be opened into the viewer by the user from a file stored locally or at a remote URL. For example, the user may load the document by typing the document's URL into the Web browser's command line.

Document Viewer 1 may be accessed by the user through any of a number of computer systems, such as through the use of a terminal connected to a mainframe system, from a personal computer, or over computer connected to a local computer network. Document Viewer 1 may also be incorporated in other networkable devices, such as Personal Digital Assistants (PDA's), laptop computers, cellular telephones, and the like.

Document Viewer 1 is connected to the Internet along with other document viewers and computers, such as Personal Computer 2 through Network Connection 4. This connection is typically made through local telephone lines using an analog, ISDN, or DSL modem, though it can be over a direct network connection, such as an Ethernet network, or a wireless or cellular system. The administrator of the network connection (e.g. an Internet Service Provider or “ISP”) maintains a computer network that routes any requests from the document viewer to the appropriate location on the Internet. This is accomplished in a conventional manner, such as through the use of a modem pool connected to a local server and Internet gateway (not shown). The network connects the document viewer to Information Exchange System 13 through any of a number of well-known connection schemes, such as through the use of leased lines.

Information Exchange System 13 may comprise Web Server 14, Data Source Interface 15, Data Source 16, and Email Server 17, the operation and interrelation of which will be described in more detail below. Of course, Information Exchange System 13 may also comprise a series of Web servers, working in tandem at the same or in geographically distributed locations.

Web Server 14 is typically a software application running on a remote computer that is capable of forwarding or processing HTTP requests from each document viewer. For example, Web Server 14 may include any one of a number of well-known server applications, such as the NSCA Web server, the Apache Web server, etc. Web Server 14 passes a document request from a document viewer to Data Source 16 using Data Source Interface 15.

Information is transmitted over the Internet using the TCP/IP protocol. With this protocol, each location on the Internet, typically a specific computer or Web server, may have its own unique IP (Internet Protocol) address. This address identifies where that computer or server is located on the network.

After a Web document is loaded into the document viewer, the document viewer waits until the hypertext link is activated, generating a signal to Web Server 14 in Information Exchange System 13. This is preferably in the form of an HTTP request sent over the Internet using TCP/IP and SSL. The HTTP request may include, for example, a request for information on the product or a purchase/hold request. It will be appreciated that the details of HTTP operation in conjunction with TCP/IP are well known to those of ordinary skill in the art and will, therefore, not be elaborated on here.

When the HTTP request is received by Web Server 14, Web Server 14 accesses Data Source 16 using Data Source Interface 15 to retrieve any requested information, or to submit information, based upon signal from the document viewer. In one embodiment of the invention, Web Server 14 would receive the HTTP request from Document Viewer 1, parsing the request to determine the desired information. In this embodiment, the requested information is accessed in Data Source 16 by using a common gateway interface (“CGI”) program, well known to those of skill in the art, as Data Interface 15. This program acts as an interface between the server and the data source by executing a set of instructions based upon the information received by the server in the HTTP request and passed by the server to the CGI program.

The CGI program can take a number of forms which are well known in the art, such as PERL scripting, C++ modules, or other common programming languages. The interaction of Web servers and CGI programs and the sending of information therebetween is well known to those of ordinary skill in the art.

The CGI program may extract the document location information, e.g. the URL, from the information passed to it by Web Server 14 and a product record or records from the data source. Conversely, it may also submit customer information from the User as well. This may be accomplished in a number of ways known to those of ordinary skill in the art. For example, if the CGI program is a PERL script, a database access module, can be used in connection with any number of database packages, such as to interface with the majority of commercial relational database applications. Examples of such databases include Oracle, Sybase, Microsoft SQL Server, and the like.

Records are stored and retrieved by passing SQL statements to the database and loading the results into the CGI program. The CGI program may then compare the records stored in Data Source 16 with any new results received from the document viewer.

Customers may access Information Exchange Server 13 in several ways. For example, if they are watching television equipped with an interactive Internet system, such as Web TV, or the like, that contains an integrated document viewer, and they see items during the television program that are available for sale that they wish to purchase, they simply click on the item on a Web page loaded into the document viewer, and it takes them to the Web site of the seller.

The Web page may be loaded into the document viewer, for example, by the User upon a cue from the producers or sponsors of the television program, may be a default Web page that is dynamically loaded with item information at the time of the show from Web servers belonging to the producers or sponsors. Such dynamic loading of Web pages is well known in the art and may be accomplished through the use of many means, such as resident applications and push technology.

The user may then research information on the item (such as price comparisons), may order the item for delivery, or they may place the item on hold at a local store for later pickup. To place the item on hold, they will then be transferred, using any number of conventional means, to the Web Server 14 in Information Exchange System 13. At this point, their geographic location will be determined. This can be done passively, such as by having them actively key in their zip code, or actively, such as by determining the IP address of the computer they are accessing the site through and determining its physical location. The determination of the general physical location of computers using IP addresses is well known to those of skill in the art and will not be elaborated upon here.

The designated geographic information is then stored in Data Source 16. Alternatively, Consumers may also go directly to Web Server 14 with their PC or handheld devices, search for merchandise available in their local stores, put them on hold in a similar manner and pick them up later. All of this may be accomplished in a conventional manner using HTML forms and hyperlinks.

Store 1 and Store 2 each have an Inventory Control System 7 and 11, respectively. Stores 1 and 2 will also have Electronic Tags 6 and 10 that are used to identify specific items in each store. Inventory Control Systems 7 and 11 may comprise any number of inventory system well known to those of skill in the art, such as systems produced by Sensormatic Corporation or CheckPoint Systems. These inventory control systems allow the staff at the store to record and track all products that come in from suppliers and distributors, are sold to customers, and/or are return to manufacturers.

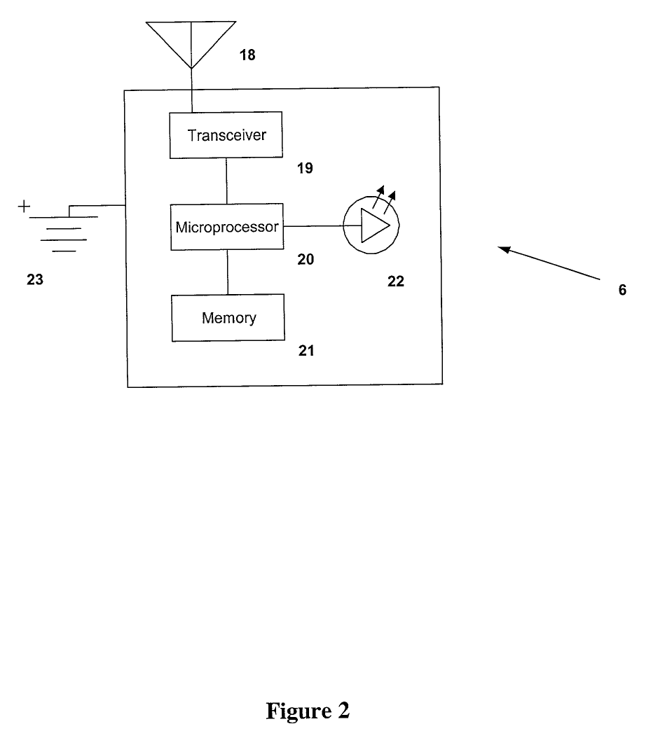

Items available to be placed on hold in Store 1 or Store 2 will have an electronic tag attached to them or the packaging surrounding them for identifying the item as being held. The electronic tag is capable of communicating with Inventory Control System 7 and 11, and of storing information, such as information about the product or about the customer who has placed the item on hold. An example of the electronic tag is shown in FIG. 2.

As shown in FIG. 2, Electronic Tag 6 or 11 may comprise Antenna 18, Transceiver 19, Microprocessor 20, Memory 21, LED 22, and Battery 23. It will be appreciated by those of skill in the art that these components may be connected in any conventional manner, and may actually comprise a number of readily purchased IC packages and the like.

Electronic Tag 6 or 11 may also have its own unique identification number, both physically printed on the tag as well as stored in Microprocessor 20. It will be appreciated that Memory 21 is both readable and writable (e.g. RAM, EEPROM, etc.), and that Transceiver 19 may work with radio wave, microwave, infrared and other communication mechanisms.

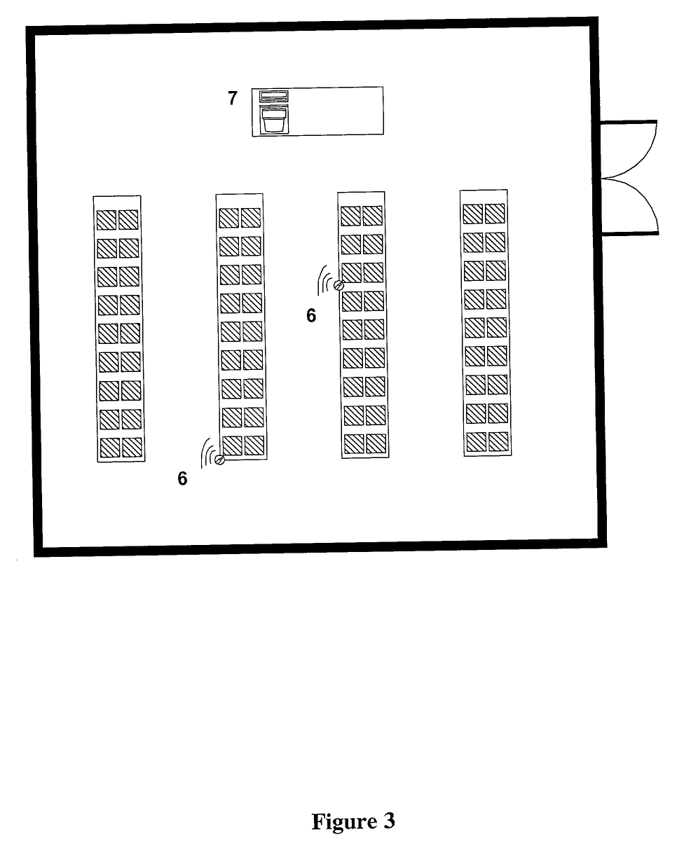

When a customer agrees to place an item on hold, a signal is transmitted from the local Information Exchange Server 13 to the designated Inventory Control System 7 or 11 at the consumer's local store over the communication network (e.g. the Internet). Inventory Control System 7 or 11 determines which electronic tag is associated with the desired product and transmits a signal containing the customer's information to the tag. Electronic Tag 6 or 10 stores this information in Microprocessor 20, and illuminates LED 21. As noted above, the information transmitted may contain the name and telephone number of the customer, along with a date, a time stamp, a tracking number, and similar types of information. Customers now entering the store will immediately see that the particular item is on hold and unavailable. This is illustrated in FIG. 3.

Electronic Tag 6 or 11 thereafter returns a signal to Inventory Control System 7 or 11, indicating that the item has been designated as being on hold. Inventory Control System 7 or 11 then sends a response back to Information Exchange Server 13 that the item has been put on hold, and Information Exchange Server 13 so notifies the customer, possibly by sending an email containing a confirmation receipt back to the consumer, using Email Server 17. The customer can now print the receipt and take it to the local store to pick up their item(s). Of course, Information Exchange Server 13 could also return an HTML page to the customer, as well, which would contain the same identifying information. The receipt may indicate the length of time this particular store will hold the item, such as 24-48 hours, and any other information about the product or the customer that is deemed necessary.

When the customer comes into the local store to pick up his/her item, Electronic Tag 6 or 10 is swiped at the point of sale, the information is recorded as sold in Information Control System 7 or 11, and the information may be sent to Information Exchange Server 13 and stored in Data Source 16. This provides the significant advantage that Information Exchange Server 13 may track how many actual items have been placed on hold versus how many were actual sales. This is preferably a closed loop system.

Electronic Tag 6 or 10 is then physically removed, reset, and kept by the store to be used again. This can be accomplished, for example, by interfacing with the stores' bar code scanner equipment in Inventory Control System 7 or 11. When a store's staff is receiving items into inventory, they may swipe the bar code from the manufacturer that contains product number, color, size, etc.

A store may wish to use its own model number instead of or in addition to that of the manufacturer. If the store wants to place Electronic Tag 6 or 10 on this item and make it available on for reservation through the system of the present invention, then Electronic Tag 6 or 10 may be placed in the bar-code interface device and the information may be written directly onto Microprocessor 20. This allows Information Exchange Server 13 to create another data record in Data Source 16 for it to monitor for during the constant polling, and updates the inventory for both the Inventory Control System 7 or 11 and Information Exchange Server 13.

Although this invention has been described with reference to particular embodiments, it will be appreciated that many variations may be resorted to without departing from the spirit and scope of this invention. For example, data source interface, and data source of the present invention may comprise a single software application, and may be operated from a single computer or a network of computers via the Internet or an internal intranet. Moreover, for example, a network of personal computers may be used, a mainframe system, or a server and peripheral thin clients.

We claim:

1. A method for reserving items over a computer network comprising the steps of:
receiving inventory information over said computer network about at least one item stored in at least one geographic location;
storing said inventory information in a data source;
receiving a request from a user to reserve said item;
generating a reservation request based upon said request from said user;
sending said reservation request to said geographic location over said computer network to activate an electronic tag assigned to said item to indicate that said item has been reserved; and
receiving a response from said geographic location that said electronic tag has been activated.

2. The method of claim 1, wherein said inventory information is received from a plurality of geographic locations, further comprising the steps of selecting at least one of said geographic locations and forwarding said reservation request to said selected geographic location.

3. The method of claim 1, further comprising the step of generating a receipt based upon said response from said geographic location.

4. The method of claim 3, further comprising the step of emailing the receipt to said user at an email address.

5. The method of claim 1, further comprising the step of storing said reservation request in said electronic tag.

6. The method of claim 1, wherein said reservation request contains one or more pieces of information selected from the group consisting of a tracking number, said user's name, said user's telephone number, and the duration of said reservation.

7. A method for reserving items over a computer network comprising the steps of:
receiving inventory information over said computer network about at least one item stored in at least one geographic location;
storing said inventory information in a data source;
receiving a request from a user to reserve said item;
generating a reservation request based upon said request from said user;
sending said reservation request to said geographic location over said computer network;
activating an electronic tag assigned to said item to indicate that said item has been reserved; and
receiving a response from said geographic location that said electronic tag has been activated.

8. The method of claim 1, wherein said inventory information is received from a plurality of geographic locations, further comprising the steps of selecting at least one of said geographic locations and forwarding said reservation request to said selected geographic location.

9. The method of claim 1, further comprising the step of generating a receipt based upon said response from said geographic location.

10. The method of claim 3, further comprising the step of emailing the receipt to said user at an email address.

11. The method of claim 1, further comprising the step of storing said reservation request in said electronic tag.

12. The method of claim 1, wherein said reservation request contains one or more pieces of information selected from the group consisting of a tracking number, said user's name, said user's telephone number, and the duration of said reservation.

13. An apparatus for reserving items over a computer network comprising:
an information exchange system connected to said computer network that is capable of:
(a) receiving inventory information over said computer network about at least one item stored in at least one geographic location;
(b) storing said inventory information in a data source;
(c) receiving a request from a user to reserve said item;
(d) generating a reservation request based upon said request from said user;
(e) sending said reservation request to said geographic location over said computer network to activate an electronic tag assigned to said item to indicate that said item has been reserved; and
(f) receiving a response from said geographic location that said electronic tag has been activated.

14. The apparatus of claim 13, wherein said information exchange system comprises a Web server, a data source interface in communication with said Web server, and a data source in communication with said data source interface.

15. The apparatus of claim 14, wherein said information exchange system further comprises an email server.

16. The apparatus of claim 13, wherein said inventory information is received from a plurality of geographic locations, and said information exchange system is capable of selecting at least one of said geographic locations and forwarding said reservation request to said selected geographic location.

17. The apparatus of claim 13, wherein said electronic tag is capable of storing said reservation request.

18. The apparatus of claim 13, wherein said reservation request contains one or more pieces of information selected from the group consisting of a tracking number, said user's name, said user's telephone number, and the duration of said reservation.
